(19) United States
(12) Patent Application Publication
(10) Pub. No.: US 2010/0034360 A1
(43) Pub. Date: Feb. 11, 2010

(54) COMMUNITY MESSAGING SERVICE

(76) Inventors: Sonny R. Bettis, Lawrenceville, GA (US); Andy Minaar, Johannesburg (ZA); Ian M. Moraes, Suwanee, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/331,651

(22) Filed: Dec. 10, 2008

Related U.S. Application Data
(60) Provisional application No. 61/087,373, filed on Aug. 8, 2008.

(51) Int. Cl. H04M 11/00; H04M 1/64; H04M 3/42; H04L 12/66

(52) U.S. Cl. 379/88.13; 379/88.17; 379/207.13; 370/352

(57) ABSTRACT

Community Messaging Service (CMS) is a system and method for operators in developing countries to provide a messaging service to subscribers who cannot yet afford a wireless telephone or personal landline service or for which such infrastructure is not readily available, but have the basic requirement to communicate with each other. CMS makes it possible for callers to leave messages for people who would otherwise be unreachable and allow subscribers to reply back to those callers. More specifically, CMS involves the use of a pre-paid account to allow callers without telephones to have a non-gsm telephone number that can be used for communication via voicemail over a Public Switched Telephone Network (PSTN).

### CROSS-REFERENCE TO RELATED APPLICATIONS

This application is being filed under 35 USC 111 and 37 CFR 1.53(b) and claims the benefit of the filing date of the U.S. Provisional Application for Patent that was filed on Aug. 8, 2008 and assigned Ser. No. 61/087,373, which application is hereby incorporated by reference in its entirety.

### BACKGROUND

If you're over thirty years of age, then you probably remember answering machines. What a breakthrough in communications technology! Answering machines became popular among the masses in the early 1980s as just about everyone who subscribed to a telephone service had one of those little black recording devices networked on their landline. Prior to answering machines, when placing a call, a caller was guaranteed one of three experiences: having his call answered, getting a “busy” signal, or listening to endless rings. Answering machines were revolutionary in that their use rendered endless rings as an obsolete feedback. With an answering machine in use, callers were guaranteed that somebody, or something, was going to answer the call.

While many folks, even today, still make use of the answering machine, the technology has long since advanced to what is commonly known as voicemail. Unlike an answering machine, a subscriber to a voicemail service advantageously doesn't have to be physically near his landline in order to listen to a message. Further, the digital nature of a voicemail system affords users access to many features including call forwarding, archiving, remote access, etc. The advantages of modern day voicemail are numerous. Regardless, whether one subscribes to voicemail or still uses an answering machine, the common feature between the two methods is that there is always the investment in a tangible, personal telephone (or cellular/mobile telephone) involved. As the evolution of voice messaging currently stands, if you can't afford, or don't have access to, a personal telephone and its corresponding service, then voice messaging is not a technology from which you may benefit.

In Africa and developing countries, many residents do not have access to a personal telephone or telephone service, much less voicemail. In fact, market studies have found that 50% of the working population in such markets cannot even afford a $10 per month mobile telephone service, much less an in-house telephone service. Further, due to illiteracy and myriad indigenous languages, the use of voice communication is predictably more usable than text messaging for this type of market. In fact, voice communication versus text communication has been found to have a lopsided ratio of 13:1 in Africa. With that in mind, one should not be surprised that markets such as these rely on a public pay telephone network as a predominant means for communication between remote parties.

If communities in Africa and other developing countries were still organized solely around a model of isolated, autonomous, self-sustaining villages, then perhaps a reasonably accessible public pay telephone network would be adequate to supplement the 99% of communication that would, undoubtedly, take place in a face to face manner. As countries such as Africa have continued to develop and grow, however, a large population of migrant workers has emerged.

Migrant workers in Africa leave their families and communities for long periods of time as they travel to work at remote jobsites. Once at the jobsite, or en route to the jobsite, it can be challenging, if not impossible, for a migrant worker to communicate with family and friends back in his home village. The family and friends he left behind likely only have access to a public telephone. So, even if the migrant worker finds a public telephone while on his journey, or is fortunate enough to have access to a mobile telephone along the way, he would still have no way of verbally communicating with his loved one unless he was somehow able to coordinate with his loved one to be at a local public pay telephone at a predetermined time.

Therefore, what is needed in the art is a community messaging service that provides a means for users to leave a voice message on a public telephone network such that the message can be retrieved at a later time by a specified subscriber.

### BRIEF SUMMARY

Community Messaging Service (CMS) is a system and method for operators in developing countries to provide a messaging service to subscribers who cannot yet afford a wireless telephone or personal landline service, but have the basic requirement to communicate with each other. CMS makes it possible for callers to leave messages for people who would otherwise be unreachable and allow subscribers to reply back to those callers. More specifically, CMS involves the use of a pre-paid account to allow callers without telephones to have a non-gsm telephone number that can be used for communication via voicemail over a Public Switched Telephone Network (PSTN).

In a typical embodiment, a subscriber to CMS is assigned a number that he may distribute to co-workers, family and friends so that a caller can dial the number and directly leave a message for the subscriber that can be retrieved at a later time. The subscriber can call the service via a public pay telephone or a friend's telephone in order to retrieve the messages, and reply or dial out using prepaid airtime.

One embodiment of the present invention includes a messaging service that is available to a subscriber by providing the subscriber with a functional telephone number for calling parties to use; however, atypical to standard functional telephone numbers, this number is not associated with a standard terminating device. Rather than being terminated as a standard call, calls to the number assigned to a subscriber are terminated by a messaging system and callers are prompted to leave a message for the subscriber. More specifically, two types of calls may be received by the system. A first type of call is from a non-subscriber to the subscriber. In response to such a call, the call is terminated by the messaging system and the calling party is prompted to leave a message. The message is then recorded and stored in a storage device.

A second type of call is one that is from a subscriber. In some embodiments, a separate number may be used by the subscriber. However, in other embodiments, the same number may be used and the subscriber can access features of the messaging system by entering an access code when the call is terminated. In either case, when the call from the subscriber is terminated, and the subscriber gains access to the system, a status message is rendered to the subscriber to indicate the presence of voice messages. In response to the subscriber providing a request for a message, the system renders or plays back a message that was previously stored for the subscriber.

In other embodiments, during a subscriber call to the system, the subscriber can initiate a call over a telephone network to a telephone number identified by the subscriber or associated with an available message. Certain embodiments may result in debiting or charging the subscribers account in response to such call initiation. In yet other embodiments, rather than initiating a call, the subscriber may simply initiate the delivery of a voice message to another party. The system can then autonomously attempt the delivery of the message to an identified destination. The message may be delivered by rendering a voice message to an answering party, rendering a voice message to a voice messaging server for the intended party, converting the voice message to text and emailing the message or rendering the converted message to a facsimile machine, or using another method depending on the various embodiments of the invention.

### BRIEF DESCRIPTION OF THE SEVERAL VIEWS OF THE DRAWING

A full and enabling disclosure of various embodiments of the present invention, including the best mode thereof is set forth in this specification which makes reference to the appended figures in which:

FIG. 1 is a system diagram depicting an exemplary architectural environment suitable for deployment of at least one embodiment of the Community Messaging System (CMS).

FIG. 2 is a flowchart illustrating an exemplary algorithm for initial configuration of an account in the CMS.

FIG. 3 is a flowchart illustrating an exemplary algorithm for changing subscriber preferences of an account in the CMS.

FIG. 4 is a flowchart illustrating an exemplary algorithm for message retrieval from an account in the CMS.

FIG. 5 is a flowchart illustrating an exemplary algorithm for placing calls and leaving messages between subscribers of accounts in the CMS.

FIG. 6 is a flowchart illustrating an exemplary algorithm for recharging the credit balance of an account in the CMS.

FIG. 7 is a timing diagram showing the relationship between actions of a subscriber, the messaging system and a calling party.

### DETAILED DESCRIPTION OF EMBODIMENTS OF THE INVENTION

Various embodiments of the present invention, along with aspects and features thereof, provide a solution to the above-described needs in the art, as well as other needs in the art by providing a subscriber with the means by which voice messages may be deposited and retrieved over a public switched telephone network without requiring the subscriber to carry a telephone device or employ a cellular telephone with GSM (global system for mobile communications) capability.

Turning now to the drawings in which like labels represent like elements throughout the drawings, various aspects, features and embodiments of the present invention will be presented in more detail. The examples set forth in the drawings and the detailed description are provided by way of explanation of the invention and are not meant as limitations of the invention. The present invention thus includes any modifications and variations of the following examples as come within the scope of the appended claims and their equivalents.

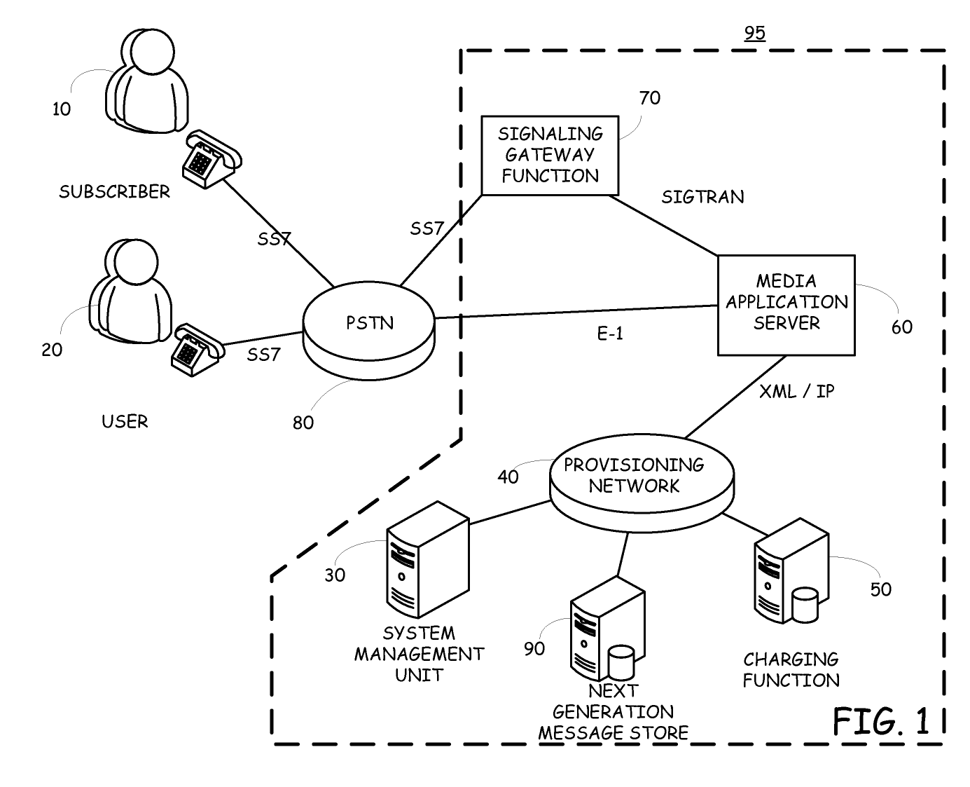

FIG. 1 is a system diagram depicting an exemplary architectural environment suitable for deployment of at least one embodiment of the Community Messaging System (CMS). At the hub of the network depicted in FIG. 1 is the Public Switched Telephone Network (PSTN) 80.

In one embodiment of the present invention, a subscriber 10 to the CMS service places a call via a public telephone to a predetermined non-GMS telephone number. As is typical of calls placed on the PSTN, the call is transported in the Signaling System 7 (SS7) protocol and directed through the PSTN 80 to a Signaling Gateway 70. The Signaling Gateway 70 converts the SS7 data into SIGTRAN, the standard telephony protocol used to convert and forward SS7 signals over the Internet. From this point, the subscriber's 10 call data is forwarded to a media application server 60 used to run the CMS Telephony User Interface (TUI) application. The media application server 60 is a component of a local provisioning network 40 that includes various database servers 50, 90 and at least one System Management Unit 30. In processing the subscriber request to retrieve voice mail previously left for him by a user 20, or initiate some other task, the media application server 60 may communicate via an internet protocol over the local provisioning network 40 to call for applets running on any of the various other database servers. For example, functions such as subscriber profile verification, message storage and retrieval, personal greeting or spoken name playback, voucher management, account debiting, etc. may reside in a slave server on the Provisioning Network 40 such as the Next Generation Message Store database server 90 or the Charging Function database server 50 depicted in FIG. 1. Further, the System Management Unit 30 residing on the Provisioning Network 40 provides a means for querying, manipulation, and configuration of the CMS system by the service provider.

It should be appreciated that FIG. 1 is a non-limiting example of a suitable architectural environment for the employment of the CMS system. Those skilled in the arts of system architecture, networking, and programming, or any combination thereof, may modify the system described herein and depicted in FIG. 1 without changing the novelty of the present invention. For example, the applets used to process various requests for features associated with the CMS may reside on multiple application servers, such as those depicted in FIG. 1, or alternatively be configured to run on a single, multi-functional server with virtual machine environments. Advantageously, regardless of the network specifics of various embodiments, a common aspect among embodiments of the invention is that subscribers and users may employ the CMS without owning, or having access to, a GSM (Global System for Mobile communications) equipped cellular telephone service or personal landline service.

It should be appreciated that a Subscriber Identification Module (SIM) based approach and a SIM-less based approach are two broad design approaches that can be used to support CMS embodiments. Novel aspects and features of CMS are not limited by the choice or combination of various system component technologies. Even so, while each approach has advantages and disadvantages, the SIM-less based CMS embodiment advantageously is more cost-wise efficient, provides a more simple and intuitive user experience, and allows for flexible billing integration. Additionally, a SIM-less based approach is more easily branded, customized, and progressively extended to support additional services than a CMS embodiment that makes use of SIM enabled devices. Advantageously, a CMS that uses SIM-less components would, obviously, not require the distribution of SIM cards to subscribers. Rather, nothing more complicated than a coin operated pay telephone connected to the PSTN would be required in order for a subscriber to make use of his non-GSM telephone number and access code to check voicemail.

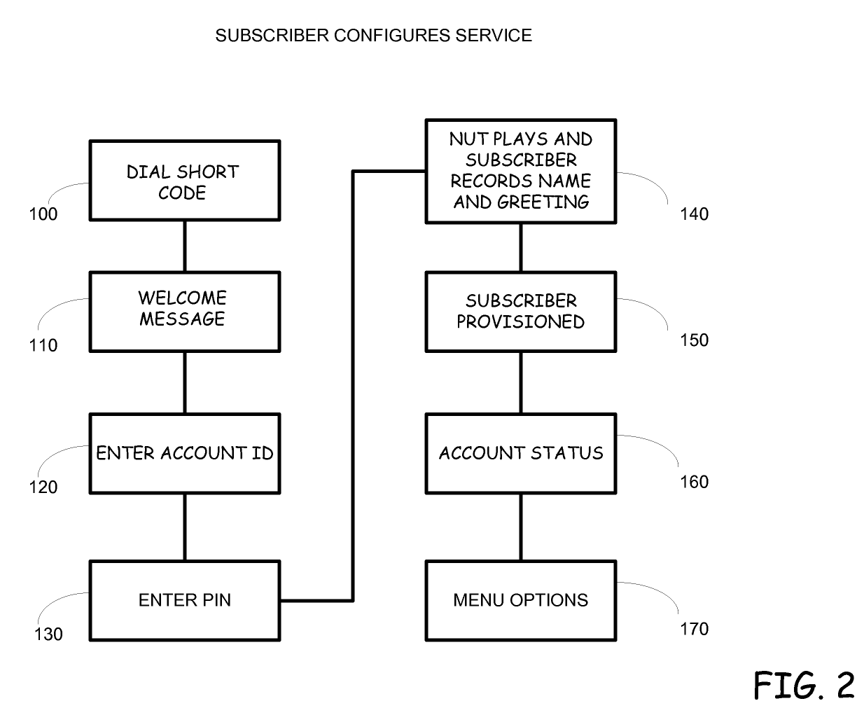

Turning now to FIG. 2 through FIG. 6, an exemplary step by step algorithm for configuring and using a CSM is described. Beginning with FIG. 2, a subscriber 10 to the CMS configures his account by dialing a number 100, which can be a typical PSTN style number, or a special short code, from any telephone or other apparatus capable of interfacing with the PSTN. For instance, the short code may include a special code prefixed by a star “*” or other special character or sequence that is recognized by the PSTN as a special number. Otherwise, the number may simply be a standard 7 or 10 digit telephone number, or a telephone number of any other length that the PSTN can recognize as a valid number and route to CMS system. Throughout this description the term short code will be used to universally refer to either a special dialing code, dialing sequence or normal PSTN number that all will result in routing the call to the CMS system. If correctly dialed, the call is routed to the CMS system and the subscriber 10 is greeted with a welcome message 110 that verifies that the subscriber 10 is connected to the CMS. Next, the subscriber 10 enters a predetermined account identification number 120, most likely in a standard telephone number format, and a personal identification number (PIN) 130. Next, the subscriber 10 follows the New User Tutorial (NUT) and proceeds to change preferences specific to his account such as the PIN, language, spoken name and greeting 140. Once the subscriber's account is provisioned 150, the credit status 160 is verified to the subscriber 10. In the final step of configuration, the subscriber 10 is directed to the CMS main menu of options 170.

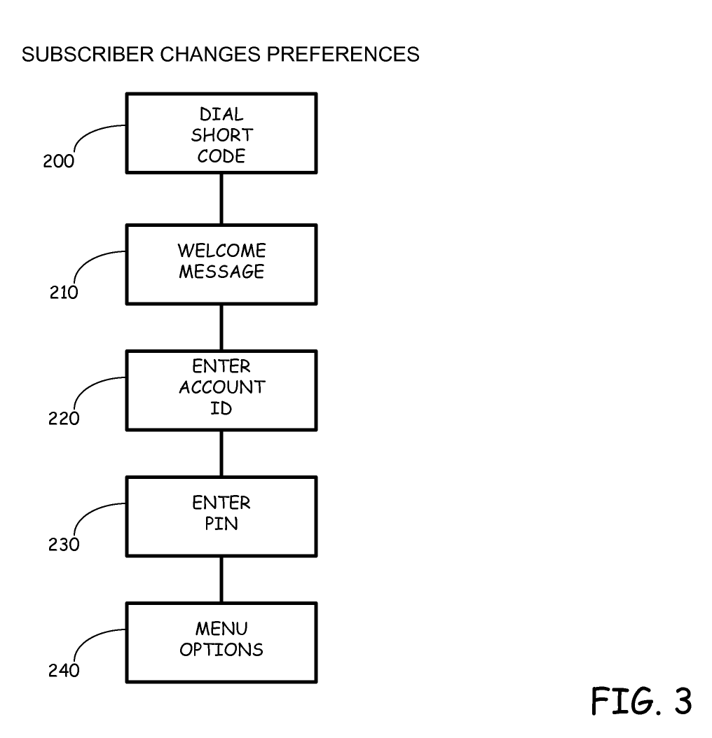

At any time after initial configuration, a subscriber 10 may change his account preferences (FIG. 3) by dialing the original number or short code 200. Upon dialing the short code 200, the subscriber is greeted with a welcome message 210 verifying the connection to the CMS. The subscriber 10 may then enter his account identification number 220 and PIN 230. Once the account ID 220 and PIN 230 are verified, the subscriber 10 is given access to a menu 240 with prompts for changing personal account preferences.

Once the account is configured, a subscriber 10 may give his subscriber assigned telephone number to any person with whom he may want to communicate via the CMS. That person is herein referred to as the user 20 depicted in FIG. 1 and is distinguishable from a subscriber 10 who is linked to a specific CMS account. The user 20 may dial the number given to him by the subscriber 10 from any telephone or apparatus capable of interfacing with the PSTN. Once the number is dialed, in some embodiments a user will hear a simulated ring prior to the subscriber's pre-recorded greeting. After being prompted, the user 20 may leave a voice message that can be retrieved by the subscriber 10 at a later time. Advantageously, because the various embodiments of the CMS do not result in routing a call to standard terminating equipment, such as handsets, mobile devices, etc., there is not a need for prolonged ring feedbacks to be given to a calling party. Typically, there is a time lag before a calling party is transitioned to a messaging service to allow time for the called party to answer the incoming call. Because there is not user accessible termination equipment associated with the subscriber assigned telephone number, the incoming call can be directly routed to the messaging service. This has several intrinsic advantages, which among other things, helps to reduce the consumption of bandwidth and provides time efficiency to the calling party.

In some embodiments, emails can be directed to the subscriber's telephone number and received by the CMS system and stored for retrieval. For instance, the CMS system can convert a received email from text into voice and make the message available for retrieval. Similarly, the CMS system can receive a faxed message and convert, as much as possible through optical character recognition techniques, the text to a voice mail message that can be retrieved by the subscriber. It should be noted that advantageously, this system is implemented without the subscriber having to subscribe to normal telephone service. For instance, the subscriber is able to access this functionality without having a landline run to his or her residence, or without even having to have a permanent residence. In addition, the subscriber is not required to purchase and obtain a mobile telephone device, such as a mobile telephone or cellular telephone. The telephone number assigned to a subscriber does not terminate on any end user equipment but, rather, terminates solely at the provisioning network 40. Messages directed towards the subscriber's telephone number are routed to the provisioning network 40 and the SMU 30, in cooperation with the media application server 60, prompts for, receives and stores within the next generation message store 90 any messages directed towards the user.

In another embodiment, the CMS system may allow a subscriber to record a message to be forwarded to another party. For instance, if a subscriber wishes to respond to a message or simply deliver a message to another CMS or non-CMS subscribing party, embodiments of the CMS system can facilitate this. The CMS system allows a subscriber to place a call to the CMS system and then during that call, allows the subscriber to record a message and then provide a destination address, such as a telephone number, email address, facsimile number, etc., for that message. Once the subscriber is completed and the subscriber call is terminated (or in some embodiments even before the subscriber call is terminated), the CMS can then attempt to deliver the message over a fixed period of time or indefinitely. Advantageously, this aspect or feature of embodiments of the invention enable a subscriber that does not own or possess his or her own terminating device to initiate the delivery of a message when they have access to a telephone device but, not require the subscriber to actually remain in the proximity of the telephone device until the intended party is contacted or the message is delivered. Utilizing this aspect, the CMS system can deliver voice messages recorded by the subscriber directly to an intended party by placing a call to a received telephone number and actually being connected to the intended party. The CMS system can also facilitate the delivery of the message by detecting an answer of a call by a voice mail system and then delivering the recorded message to the intended party's voice mail. If the subscriber provides the CMS system with a facsimile number, the CMS system can convert the voice message into a facsimile message and delivery the facsimile to the provided number. Further, if the destination information is an email address, the CMS system can convert the recorded message into text and route the message to the provided email address. It will also be appreciated that a text message or SMS message may be delivered if the provided destination information supports such messaging types.

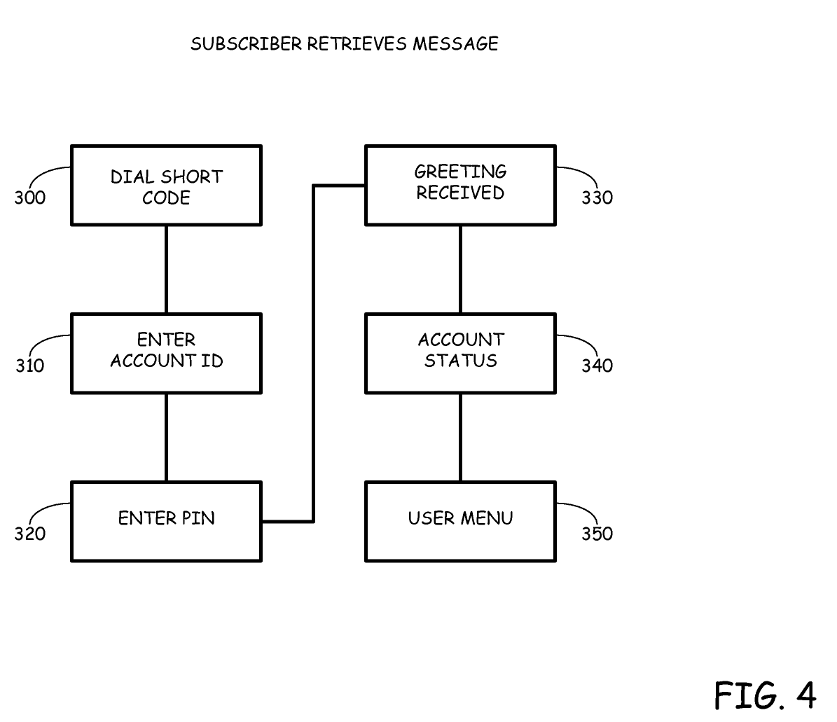

In order to retrieve a message (FIG. 4), a subscriber 10 dials a short code 300 from any telephone or apparatus connectible to the PSTN. Next, the subscriber 10 enters his account ID 310 and PIN 320. The subscriber 10 receives his personal greeting 330 for the purpose of intuitively verifying that he is connected to the correct account. The subscriber 10 is then briefed on account status 340 of variables such as unchecked messages, saved messages, or credit balance and then linked to a user menu 350 with prompts for listening to messages, leaving a message for another subscriber, recharging credit, etc.

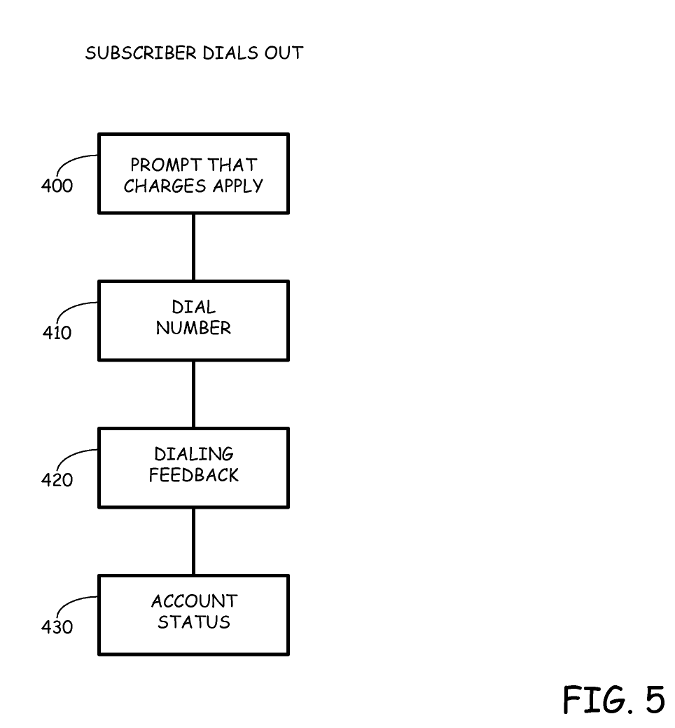

From the user menu 350, a subscriber 10 may choose to “dial out” (FIG. 5) and leave a message to another subscriber. In doing so, the subscriber 10 would be prompted that his account will be debited 400 prior to his dialing the given number 410. If the subscriber 10 proceeds with the “dial out,” feedback 420 is given to verify that the number is being dialed (a ring, for example) and the subscriber 10 is connected to the greeting associated with the dialed number. After leaving a message, the subscriber 10 is once again briefed as to his account status 430 and may access the main menu or terminate the call.

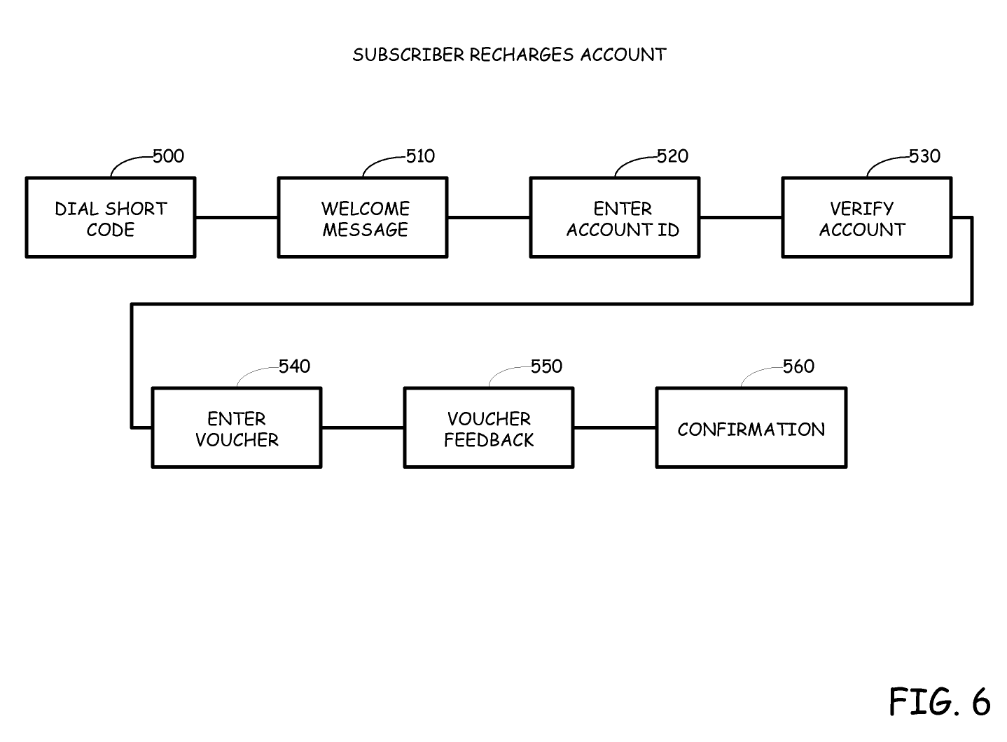

In addition to retrieving messages and placing outgoing calls to other subscribers, a subscriber 10 may recharge the credit balance on his account (FIG. 6). Because the embodiment being described herein is a non-limiting example of a CMS that employs non-SIM capable components, a subscriber 10 wanting to recharge his account would purchase a voucher from an agent or other sales channel for a given amount. Once the voucher is purchased, the subscriber 10 can dial a short code 500 connecting him to the CMS. After receiving the standard welcome message 510, the subscriber would enter his account ID 520. Once the CMS verifies to the subscriber 10 that the correct account has been accessed 530, the voucher code can be entered 540 and feedback as to credit status stated 550. Finally, the recharge is confirmed 560 and the subscriber is linked to the main menu.

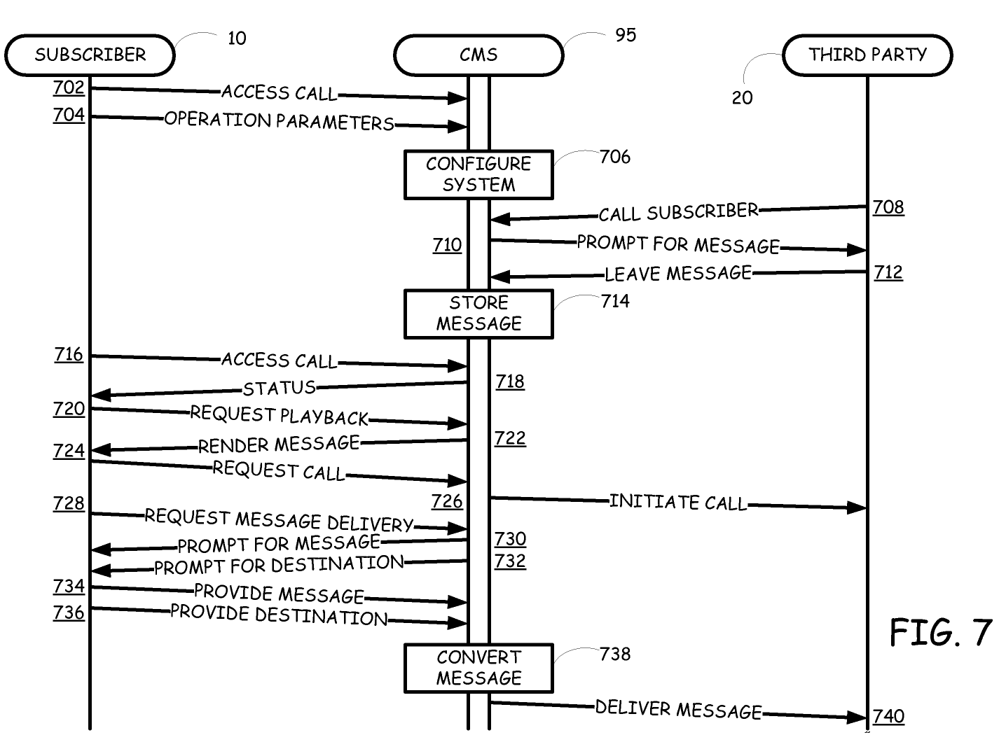

FIG. 7 is a timing diagram showing the relationship between actions of a subscriber, the messaging system and a calling party. The subscriber 10 is shown as initially accessing the CMS 95 by placing an access call to the system 702. As previously described, such access call may be to a common system access number and the user may then be required to enter a code, or the call may be to a subscriber access number specifically assigned to the subscriber for system access, or the call may be to a subscriber number assigned to the subscriber and also require a code to select administrative mode rather than message delivery mode (which would be used by third parties calling into to the subscriber). When the call is terminated at the CMS 95, the subscriber may provide operation parameters, or configuration parameters or commands 704. In response to these commands or parameters, the CMS 95 then configures the system for the subscriber 706.

Subsequent to this time, the CMS 95 is then available for third parties 20 to leave messages for the subscriber 10. It should also be appreciated that the subscriber can repeat the configuration process after the initial configuration process to change, modify or augment the operation of the CMS 95. The third party provides a message to the subscriber 10 by placing a call to the subscriber using a number specifically assigned to the subscriber 708. It should be appreciated that the number called by the third party 20 may also be a common or shared number and, to specifically access or direct a message to the subscriber, the third party may be required to enter an identification or redirection code. Once the call from the third party 20 is terminated by the CMS 95, the CMS 95 prompts the third party to leave a message 710. The message is then delivered to the CMS 95 712 and the CMS 95 stores the message for the subscriber 714.

The subscriber 10, at any time, may place an access call to the CMS 95. Subsequent to a message being left for the subscriber 10, if the subscriber 10 places an access call 716, the CMS 95 will respond with a status message 718 indicating that one or more messages have been received. The subscriber 10 can request the playback of a message 720 which results in the CMS 95 rendering a message 722 to the subscriber 10. In addition, or in lieu of requesting a message playback, the subscriber 10 may also request a call to a third party 724, to which the CMS 95 will respond by initiating the call 726 and, in some embodiments, charging the subscriber 10 for the service. Furthermore, the subscriber 10 may also in addition or in lieu of, request a message to be delivered to a third party 728. In response to this request, the CMS 95 then prompts the subscriber 10 for the message 730 and also prompts for the destination identification for the message 732. The subscriber 10 responds to these prompts respectively by providing and/or selecting a message 734 and a destination 736. The CMS 95 then converts the message 738 as necessary and initiates or delivers the message to the identified destination 740.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above or in the attached exhibits. Rather the scope of the invention is defined by the claims that follow.

What is claimed is:

1. A messaging system for providing a messaging service independent from a requirement for a terminating device, the messaging service including receiving, storing and retrieving voice-based messages and allowing a subscriber to configure the operation thereof, the messaging system comprising:
a signaling gateway that interfaces to a telephone network and operates as a termination point for a call directed to an access number and a call directed to a subscriber assigned number, both the access number and the subscriber assigned number being associated with the messaging service;
a media server for providing an interactive user interface to a subscriber accessing the messaging system by dialing the access number, the media server being operable to provision the subscriber account and receive parameters to define the operation of the subscriber account, as well as provide message status information to the subscriber and allow retrieval of stored messages;
the media server also providing an interactive user interface to a calling party dialing the subscriber assigned number, the media server being operable to prompt for, receive and store a message from the calling party directed towards the subscriber;
a provisioning system, accessible over an IP network by the media server, and operable to provide message storage services, message retrieval services and billing services to the subscriber.

2. The messaging system of claim 1, wherein the access number and the subscriber assigned number are the same and wherein the media server is further operable to receive an access code to enter a provisioning mode of operation.

3. The messaging system of claim 1, wherein the media server is operable, in response to receiving a request from a subscriber, initiate an outbound call to a telephone number associated with a retrieved message.

4. The messaging system of claim 3, wherein the media server is further operable to interface with the provisioning system to invoke a charge for the subscriber to initiate an outbound call.

5. The messaging system of claim 4, wherein the provisioning system is operable to provide billing services to the subscriber by receiving a voucher number from the subscriber and crediting a value to an account associated with the subscriber in response to receiving the voucher number.

6. The messaging system of claim 1, wherein the media server is further operable to receiving a voice message from the subscriber along with a destination address for the voice message during a subscriber call to the messaging system and, then proceed to attempt the delivery of the voice message to the destination address after the subscriber call is terminated.

7. A method for providing a messaging service to a subscriber by providing the subscriber with a functional telephone number for calling parties to use, wherein the functional telephone number terminates at a messaging system rather than an end user device, the method comprising the steps of:
receiving a first call directed to the functional telephone number;
terminating the first call without attempting to route the call to a destination device;
prompting the calling party of the first call to leave a message;
recording the message from the calling party of the first call;
storing the message into a storage device;
receiving a second call directed to the functional telephone number;
terminating the second call without attempting to route the call to a destination device;
receiving an access code from the calling party of the second call, the access code providing access to an administrative function;
rendering a message status message to the calling party of the second call; and
in response to a signal to playback a message, extract a message from the storage device and rendering it to the calling party of the second call.

8. The method of claim 7, further comprising the steps of
receiving a request to initiate a call by the calling party of the second call, wherein the calling party of the second call is the subscriber;
initiating a call over a telephone network to a telephone number identified by the subscriber; and
debiting an account associated with the subscriber for initiating the call.

9. The method of claim 7, further comprising the steps of:
receiving a request to initiate a message delivery by the calling party of the second call, wherein the calling party of the second call is the subscriber;
prompting the subscriber to recite a voice message;
storing the voice message;
receiving a destination identifier for the voice message; and
delivering the voice message to the destination identifier.

10. The method of claim 9, wherein the destination identifier is a telephone number and the step of delivering the voice message to the destination identifier further comprises the steps of:
initiating a call to the telephone number; and
upon detecting a termination of the call, rendering the voice message.

11. The method of claim 9, wherein the destination identifier is a telephone number and the step of delivering the voice message to the destination identifier further comprises the steps of:
initiating a call to the telephone number; and
upon detecting a termination of the call by an voice mail system, delivering the voice message to the voice mail system.

12. The method of claim 9, wherein the destination identifier is an email address and the step of delivering the voice message to the destination identifier further comprises the steps of:
converting the voice message to a text message; and
forwarding the text message to the identified email address.
